(19) United States
(12) Patent Application Publication
(10) Pub. No.: US 2023/0015797 A1
(43) Pub. Date: Jan. 19, 2023

(54) USER TERMINAL AND CONTROL METHOD THEREFOR

(71) Applicant: Kyung Cheol KIM, Cheongju-si (KR)

(72) Inventor: Kyung Cheol KIM, Cheongju-si (KR)

(21) Appl. No.: 17/784,034

(22) PCT Filed: Dec. 7, 2020
(86) PCT No.: PCT/KR2020/017742

§ 371 Date: Jun. 9, 2022

(30) Foreign Application Priority Data
Dec. 9, 2019 (KR) 10-2019-0162504

(51) Int. Cl. G06F 40/58; H04N 21/233; H04N 21/234

(52) U.S. Cl. CPC G06F 40/58; H04N 21/233; H04N 21/234

(57) ABSTRACT

Disclosed are a user terminal and a control method therefor. A user terminal according to an aspect may include: an extraction unit that extracts original language information pertaining to each character on the basis of at least one among a video file and an audio file separately generated from a moving image file; a translation unit that generates translation information obtained by translating the original language information according to a selected language; and a control unit that provides at least one among the original language information and the translation information.

### TECHNICAL FIELD

The present invention relates to a user terminal that provides a translation service for a video, and a control method thereof.

### BACKGROUND ART

With the advancement in IT technology, various types of video contents are easily transmitted/shared between users. In particular, in line with global trends, users transmit/share overseas video contents produced in various languages, as well as domestic video contents.

However, as a lot of video contents are produced, not all video contents are translated, and therefore, researches on a method of providing a real-time translation service are under progress to increase users' convenience.

### DISCLOSURE OF INVENTION

### Technical Problem

Therefore, the present invention has been made in view of the above problems, and an object of the present invention is to provide a translation providing service, as well as an original language providing service, in real-time for video contents desired by a user so that the user may enjoy video contents more easily, and to make it possible to translate all the video contents although various communication means are included in the video contents and provide a translation service through at least one among a voice and text so that the visually impaired and the hearing impaired may also freely enjoy the video contents.

### Technical Solution

To accomplish the above object, according to one aspect of the present invention, there is provided a user terminal comprising: an extraction unit for extracting original language information for each character based on at least one among an image file and an audio file separately generated from a video file; a translation unit for generating translation information obtained by translating the original language information according to a selected language; and a control unit for providing at least one among the original language information and the translation information.

In addition, the original language information may include at least one among voice original language information and text original language information, and the translation information includes at least one among voice translation information and text translation information.

In addition, the extraction unit may extract voice original language information for each character by applying a frequency band analysis process to the audio file, and generate text original language information by applying a voice recognition process to the extracted voice original language information.

In addition, the extraction unit may detect a sign language pattern by applying an image processing process to the image file, and generate text original language information based on the detected sign language pattern.

In addition, the extraction unit may determine at least one among an age group and a gender of a character appearing in the audio file through a frequency band analysis process, map character information set based on a determination result to the original language information, and store the character information.

According to another aspect of the present invention, there is provided a control method of a user terminal, the method comprising the steps of: extracting original language information for each character based on at least one among an image file and an audio file separately generated from a video file; generating translation information obtained by translating the original language information according to a selected language; and providing at least one among the original language information and the translation information.

In addition, the extracting step may include the steps of extracting the original language information for each character based on at least one among an image file and an audio file according to a communication means included in the video file.

In addition, the extracting step may include the steps of: extracting voice original language information for each character by applying a frequency band analysis process to the audio file; and generating text original language information by applying a voice recognition process to the extracted voice original language information.

In addition, the extracting step may include the step of detecting a sign language pattern by applying an image processing process to the image file, and generating text original language information based on the detected sign language pattern.

In addition, the extracting step may include the step of determining at least one among an age group and a gender of a character appearing in the audio file through a frequency band analysis process, mapping character information set based on a determination result to the original language information, and storing the character information.

### Advantageous Effects

A user terminal and a control method according to an embodiment provides a translation providing service, as well as an original language providing service, in real-time for video contents desired by a user so that the user may enjoy video contents more easily.

A user terminal and a control method according to another embodiment make it possible to translate all the video contents although various communication means are included in the video contents and provide a translation service through at least one among a voice and text so that the visually impaired and the hearing impaired may also freely enjoy the video contents.

### BRIEF DESCRIPTION OF THE DRAWINGS

FIG. 1 is a view schematically showing the appearance of a user terminal according to an embodiment.

FIG. 2 is a block diagram schematically showing the configuration of a user terminal according to an embodiment.

FIG. 3 is a view showing a user interface screen displayed on a display according to an embodiment.

FIG. 4 is a view showing a user interface screen for providing original language information through a display according to an embodiment.

FIGS. 5 and 6 are views showing a user interface screen that provides at least one among original language information and translation information through a display according to another embodiment.

FIG. 7 is a flowchart schematically showing the operation flow of a user terminal according to an embodiment.

### BEST MODE FOR CARRYING OUT THE INVENTION

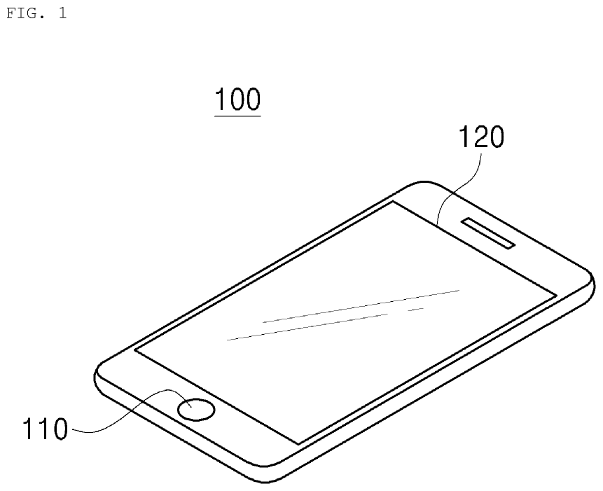

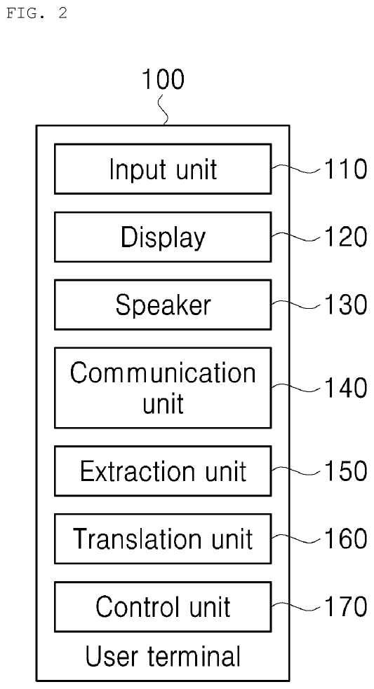

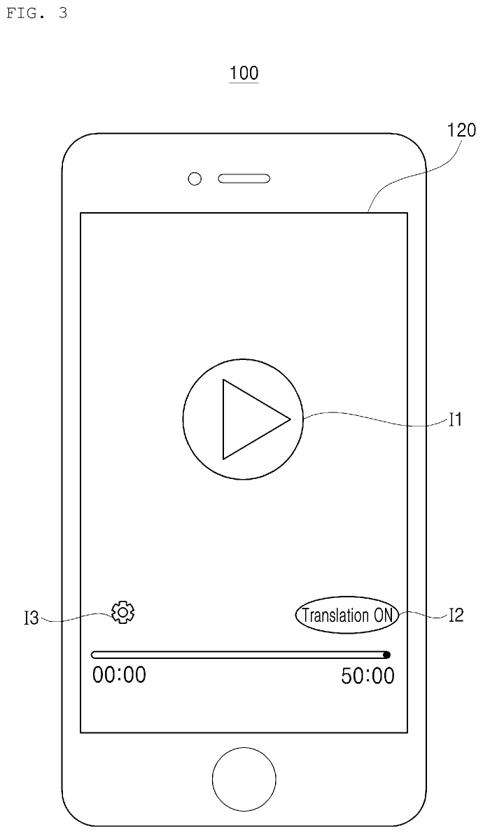

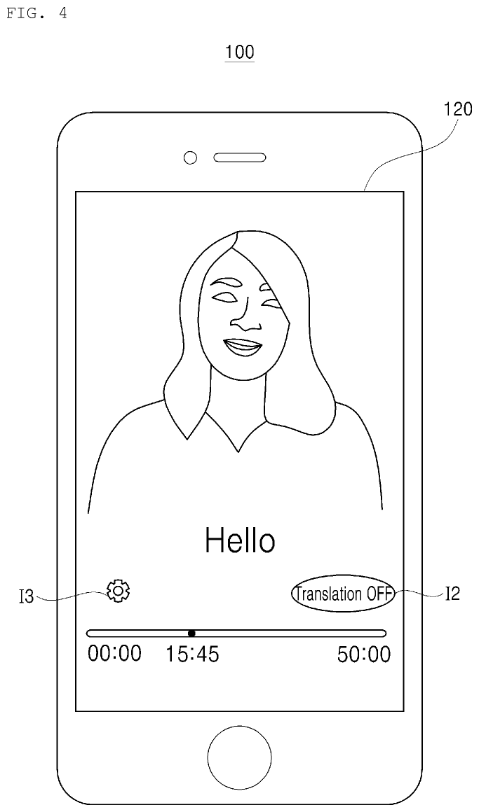

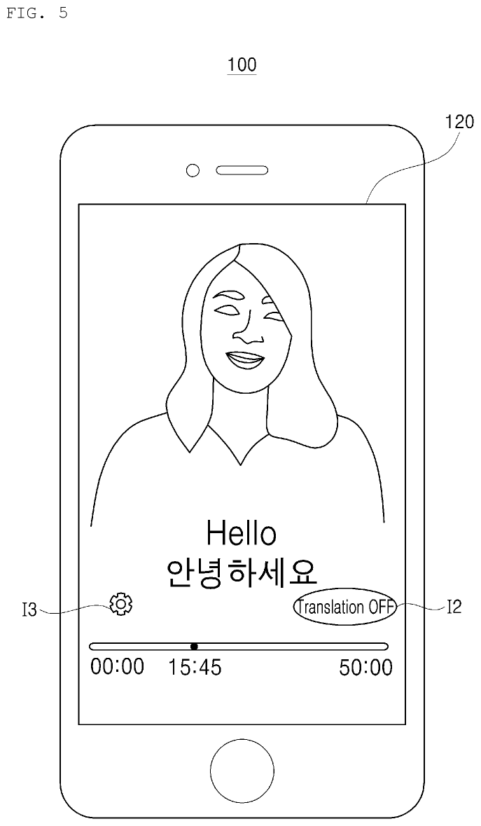

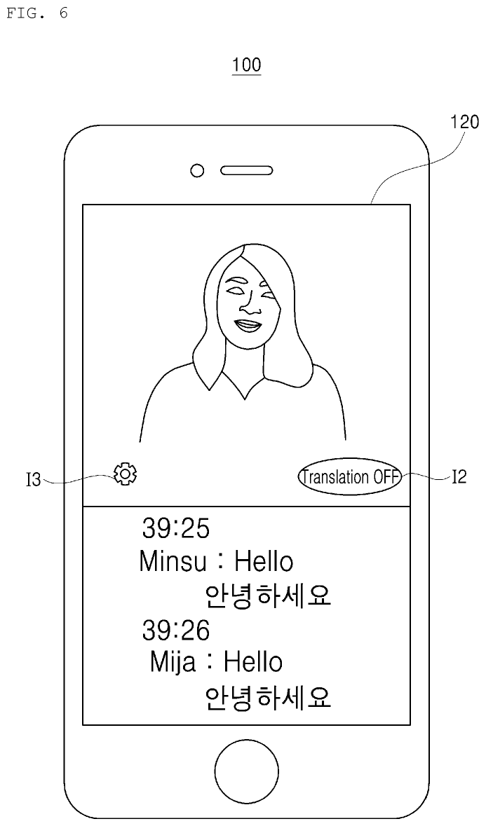

FIG. 1 is a view schematically showing the appearance of a user terminal according to an embodiment, and FIG. 2 is a block diagram schematically showing the configuration of a user terminal according to an embodiment. In addition, FIG. 3 is a view showing a user interface screen displayed on a display according to an embodiment, and FIG. 4 is a view showing a user interface screen for providing original language information through a display according to an embodiment. In addition, FIGS. 5 and 6 are views showing a user interface screen that provides at least one among original language information and translation information through a display according to another embodiment. Hereinafter, they will be described together to prevent duplication of description.

The user terminal described below includes all devices that can play back a video file as a display and a speaker, as well as a processor capable of performing various arithmetic operations, are embedded therein.

For example, the user terminal includes smart TVs (Television), IPTVs (Internet Protocol Television), and the like, as well as laptop computers, desktop computers, tablet PCs, mobile terminals such as smart phones and personal digital assistants (PDAs), and wearable terminals in the form of a watch or glasses that can be attached to a user's body, and there is no limitation. Although a user terminal of a smart phone type among the various types of user terminals described above will be described hereinafter as an example for convenience of explanation, it is not limited thereto.

Referring to FIGS. 1 and 2, the user terminal 100 may include an input unit 110 for receiving various commands from a user, a display 120 for visually providing various types of information to the user, a speaker 130 for aurally providing various types of information to the user, a communication unit 140 for exchanging various types of data with an external device through a communication network, an extraction unit 150 for extracting original language information using at least one among an image file and an audio file generated from a video file, a translation unit 160 for generating translation information by translating the original language information in a language requested by the user, and a control unit 170 for providing an original text/translation service by providing at least one among the original language information and the translation information by controlling the overall operation of the components in the user terminal 100.

Here, the communication unit 140, the extraction unit 150, the translation unit 160, and the control unit 170 may be implemented separately, or at least one among the communication unit 140, the extraction unit 150, the translation unit 160, and the control unit 170 may be implemented to be integrated in a system-on-chip (SOC), and there is no limitation in the implementation method. However, since there may be one or more system-on-chips in the user terminal 100, it is not limited to integration in one system-on-chip, and there is no limitation in the implementation method. Hereinafter, each component of the user terminal 100 will be described in detail.

First, referring to FIGS. 1 and 2, the user terminal 100 may be provided with an input unit 110 for receiving various commands from a user. For example, the input unit 110 may be provided on one side of the user terminal 100 as a hard key type as shown in FIG. 1. In addition, when the display 120 is implemented as a touch screen type, the display 120 may perform the functions of the input unit 110 instead.

The input unit 110 may receive various control commands from a user. For example, the input unit 110 may receive a command for setting a language desired to translate, a command for extracting original text, and a command for executing a translation service, as well as a command for playing back a video, from the user. In addition, the input unit 110 may receive various control commands, such as a command for storing original language information and translation information, and the control unit 170 may control operation of the components in the user terminal 100 according to the received control commands. A detailed description of the original language information and the translation information will be provided below.

Referring to FIGS. 1 and 2, the user terminal 100 may be provided with a display 120 that visually provides various types of information to the user. The display 120 may be provided on one side of the user terminal 100 as shown in FIG. 1, but it is not limited thereto, and there is no limitation.

According to an embodiment, the display 120 may be implemented as a liquid crystal display (LCD), a light emitting diode (LED), a plasma display panel (PDP), an organic light emitting diode (OLED), a cathode ray tube (CRT), and the like, but it is not limited thereto, and there is no limitation. Meanwhile, when the display 120 is implemented as a touch screen panel (TSP) type as described above, it may perform the function of the input unit 110 instead.

When the display 120 is implemented as a touch screen panel type, it may display a video requested by the user, and may also receive various control commands through the user interface displayed on the display 120.

The user interface described below may be a graphical user interface, which graphically implements a screen displayed on the display 120, so that the operation of exchanging various types of information and commands between the user and the user terminal 100 may be performed more conveniently.

For example, the graphical user interface may be implemented to display icons, buttons and the like for easily receiving various control commands from the user in a specific region on the screen displayed through the display 120, and display various types of information through at least one widget in other regions, and there is no limitation.

Referring to FIG. 3, a graphical user interface including an icon I1 for receiving a video playback command, an icon I2 for receiving a translation command, and an icon for receiving various setting commands I3, in addition to the commands described above, may be displayed on the display 120.

The control unit 170 may control to display the graphical user interface as shown in FIG. 3 on the display 120 through a control signal. The display method, arrangement method and the like of widgets, icons, and the like configuring the user interface may be implemented as a data in the form of an algorithm or a program and previously stored in the memory of the user terminal 100, and the control unit 170 may control to generate a control signal using the previously stored data and display the graphical user interface through the generated control signal. A detailed description of the control unit 170 will be described below.

Meanwhile, referring to FIG. 2, the user terminal 100 may be provided with a speaker 130 capable of outputting various sounds. The speaker 130 is provided on one side of the user terminal 100 and may output various sounds included in a video file. The speaker 130 may be implemented through various types of known sound output devices, and there is no limitation.

The user terminal 100 may be provided with a communication unit 140 for exchanging various types of data with external devices through a communication network.

The communication unit 140 may exchange various types of data with external devices through a wireless communication network or a wired communication network. Here, the wireless communication network means a communication network capable of wirelessly transmitting and receiving signals including data.

For example, the communication unit 140 may transmit and receive wireless signals between terminals through a base station in a 3-Generation (3G), 4-Generation (4G), or 5-Generation (5G) communication method, and in addition, it may exchange wireless signals including data with terminals within a predetermined distance through a communication method, such as wireless LAN, Wi-Fi, Bluetooth, Zigbee, Wi-Fi Direct (WFD), Ultra-wideband (UWB), Infrared Data Association (IrDA), Bluetooth Low Energy (BLE), Near Field Communication (NFC), or the like.

In addition, the wired communication network means a communication network capable of transmitting and receiving signals including data by wire. For example, the wired communication network includes Peripheral Component Interconnect (PCI), PCI-express, Universal Serial Bus (USB), and the like, but it is not limited thereto. The communication network described below includes both a wireless communication network and a wired communication network.

The communication unit 140 may download a video from a server located outside through a communication network, and transmit information translated based on the language of a country included in the video to an external terminal together with the video, and there is no limitation in the data that can be transmitted and received.

Referring to FIG. 2, the user terminal 100 may be provided with the extraction unit 150.

In order to provide a translation service, recognition of an original language is required first. Accordingly, the extraction unit 150 may separately generate an image file and an audio file from the video file, and then extract original language information from at least one among the image file and the audio file.

The original language information described below means information extracted from a communication means such as a voice, a sign language, or the like included in the video, and the original language information may be extracted in the form of a voice or text. Hereinafter, for convenience of explanation, original language information configured of a voice will be referred to as voice original language information, and original language information configured of text will be referred to as text original language information. For example, when a character appearing in a video speaks ‘Hello’ in English, the voice original language information is the voice ‘Hello’ spoken by the character, and the text original language information means text ‘Hello’ itself converted based on a recognition result after the voice ‘Hello’ is recognized through a voice recognition process.

Meanwhile, the method of extracting the original language information may be different according to a communication means, for example, whether the communication means is a voice or a sign language. Hereinafter, a method of extracting voice original language information from a voice file containing voices of characters will be described first.

Voices of various characters may be contained in the audio file, and when these various voices are output at the same time, it may be difficult to identify the voices, and accuracy of translation may also be lowered. Accordingly, the extraction unit 150 may extract voice original language information for each character by applying a frequency band analysis process to the audio file.

The voice of each individual may be different according to gender, age group, pronunciation tone, pronunciation strength, or the like, and the voices may be individually identified by grasping corresponding characteristics when the frequency band is analyzed. Accordingly, the extraction unit 150 may extract voice original language information by analyzing the frequency band of the audio file and separating the voice of each character appearing in the video based on the analysis result.

The extraction unit 150 may generate text original language information, which is text converted from the voice, by applying a voice recognition process to the voice original language information. The extraction unit 150 may separately store the voice original language information and the text original language information for each character.

The method of extracting voice original language information for each character through a frequency band analysis process and the method of generating text original language information from the voice original language information through a voice recognition process may be implemented as a data in the form of an algorithm or a program and previously stored in the user terminal 100, and the extraction unit 150 may separately generate original language information using the previously stored data.

Meanwhile, a character appearing in a video may use a sign language. In this case, unlike the method of extracting voice original language information from the audio file and then generating text original language information from the voice original language information, the extraction unit 150 may extract the text original language information directly from an image file. Hereinafter, a method of extracting text original language information from an image file will be described.

The extraction unit 150 may detect a sign language pattern by applying an image processing process to an image file, and generate text original language information based on the detected sign language pattern. Whether or not to apply an image processing process may be set automatically or manually. For example, when a sign language translation request command is received from the user through the input unit 110 or the display 120, the extraction unit 150 may detect a sign language pattern through the image processing process. As another example, the extraction unit 150 may automatically apply an image processing process to the image file, and there is no limitation.

The method of detecting a sign language pattern through an image processing process may be implemented as a data in the form of an algorithm or a program and previously stored in the user terminal 100, and the extraction unit 150 may detect a sign language pattern included in the image file using the previously stored data, and generate text original language information from the detected sign language pattern.

The extraction unit 150 may store the original language information by mapping it with character information. The character information may be arbitrarily set according to a preset method or adaptively set according to the characteristics of a character detected from the video file.

For example, the extraction unit 150 may identify the gender, age group, and the like of a character who makes a voice through a frequency band analysis process, and arbitrarily set and map a character's name determined to be the most suitable based on the result of the identification.

As an embodiment, when it is determined that the first character is a man in his twenties and the second character is a woman in his fortis as a result of analyzing the voice through a frequency band analysis process, the extraction unit 150 may set and map ‘Minsu’ as the character information for the original language information of the first character and ‘Mija’ as the character information for the original language information of the second character.

As another example, the control unit 170 may set a character name detected from the text original language information as the character information, and there is no limitation in the method of setting the character information.

The control unit 170 may display the mapped character information together when the original language information is provided through the display 120 and the speaker 130, and may also display the mapped character information together when the translation information is provided. For example, as shown in FIG. 6, the control unit 170 may control to display a user interface configured to provide the character information set by itself, together with the original language information and the translation information, on the display 120.

Meanwhile, the mapped character information may be changed by the user, and the mapped character information is not limited as described above. For example, the user may set desired character information through the input unit 110 and the display 120 implemented as a touch screen type, and there is no limitation.

Referring to FIG. 2, the user terminal 100 may be provided with a translation unit 160. The translation unit 160 may generate translation information by translating the original language information in a language desired by a user. In translating the original language information in a language of a country input by a user, the translation unit 160 may generate a translation result as text or a voice. Hereinafter, information on the original language information translated in a language of another country is referred to as translation information for convenience of explanation, and the translation information may also be configured in the form of a voice or text, like the original language information. At this point, translation information configured of text will be referred to as text translation information, and translation information configured of a voice will be referred to as voice translation information.

The voice translation information is voice information dubbed with a specific voice, and the translation unit 160 may generate voice translation information dubbed in a preset voice or a tone set by a user. The tone that each user desires to hear may be different. For example, a specific user may desire voice translation information of a male tone, and another user may desire voice translation information of a female tone. Alternatively, the translation unit 160 may adaptively set the tone according to the gender of the character identified through the frequency band analysis process described above.

As a translation method and a voice tone setting method used for translation, data in the form of an algorithm or a program may be previously stored in the user terminal 100, and the translation unit 160 may perform translation using the previously stored data.

Referring to FIG. 2, the user terminal 100 may be provided with a control unit 170 for controlling the overall operation of the components in the user terminal 100.

The control unit 170 may be implemented as a processor, such as a micro control unit (MCU) capable of processing various arithmetic operations, and a memory for storing control programs or control data for controlling the operation of the user terminal 100 or temporarily storing control command data or image data output by the processor.

At this point, the processor and the memory may be integrated in a system-on-chip (SOC) embedded in the user terminal 100. However, since there may be one or more system-on-chips embedded in the user terminal 100, it is not limited to integration in one system-on-chip.

The memory may include volatile memory (also referred to as temporary storage memory) such as SRAM and DRAM, and non-volatile memory such as flash memory, Read Only Memory (ROM), Erasable Programmable Read Only Memory (EPROM), Electrically Erasable Programmable Memory (EEPROM), and the like. However, it is not limited thereto, and may be implemented in any other forms known in the art.

In an embodiment, control programs and control data for controlling the operation of the user terminal 100 may be stored in the non-volatile memory, and the control programs and control data may be retrieved from the non-volatile memory and temporarily stored in the volatile memory, or control command data or the like output by the processor may be temporarily stored in the volatile memory, and there is no limitation.

The control unit 170 may generate a control signal based on the data stored in the memory, and may control the overall operation of the components in the user terminal 100 through the generated control signal.

The control unit 170 may control to display various types of information on the display 120 through a control signal. For example, the control unit 170 may play back a video requested by a user on the display 120 through a control signal. In an embodiment, when the user touches the icon I2 shown in FIG. 3, the control unit 170 controls the components of the user terminal 100 to provide at least one among text translation information and voice translation translated in a language of a country set by the user.

For example, the control unit 170 may control to display the text translation information on the display 120 together with the video, and the control unit 170 may control to transmit the voice translation information through the speaker 130.

The method of providing the original language information and the translation information by the control unit 170 may be diverse. For example, as shown in FIG. 4, the control unit 170 may control to map the text original language information to the video as a subtitle and then display the video on the display 120.

As another example, as shown in FIG. 5, the control unit 170 may control to map the text original language information and the text translation information to the video as a subtitle, and then display them together on the display 120. In addition, the control unit 170 may control to display the text original language information first, and then display the text translation information as a subtitle after a preset interval.

As still another example, the control unit 170 may control to output the voice original language information through the speaker 130 whenever a character speaks in a video, and then output the voice translation information dubbed with a specific voice after a preset interval. At this point, the control unit 170 may control to adjust the output magnitude of the voice original language information and the voice translation information differently, and there is no limitation in the method of providing the original text/translation service.

Although the user terminal 100 itself may perform the process of separately generating an image file and an audio file from a video file, the process of extracting original language information from the image file and the audio file, and the process of generating translation information from the original language information, in order to prevent overload of arithmetic processing, the processes may be separately performed in a device provided outside. In this case, when the device provided outside receives a translation command from the user terminal 100, it may perform the processes described above and then transmit a result to the user terminal 100, and there is no limitation.

Hereinafter, the operation of a user terminal supporting a translation service for a video will be described briefly.

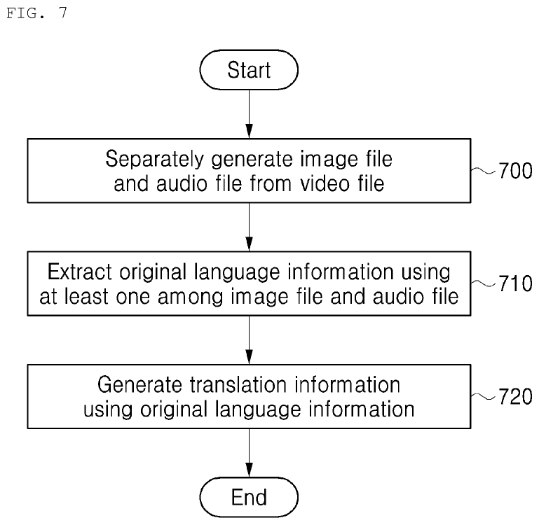

FIG. 7 is a flowchart schematically showing the operation flow of a user terminal according to an embodiment.

Referring to FIG. 7, the user terminal may separately generate an image file and an audio file from a video file (700). Here, the video file may be a file previously stored in the user terminal or a file streaming in real-time through a communication network, and there is no limitation.

For example, the user terminal may read a video file stored in the embedded memory, and generate an image file and an audio file based on the video file. As another example, the user terminal may receive video file data in real-time through a communication network, and generate an image file and an audio file based on the video file data.

The user terminal may extract original language information using at least one among the image file and the audio file (710).

Here, the original language information is information expressing the communication means included in the original video file in the form of at least one among a voice and text, and it corresponds to the information before being translated in a language of a specific country.

The user terminal may extract the original language information by using both or only one among the image file and the audio file according to a communication means used by the character appearing in the video.

For example, when any one of the characters appearing in the video has a conversation using a voice while another character has a conversation using a sign language, the user terminal may extract the original language information by identifying a sign language pattern from the image file and a voice from the audio file.

As another example, when the characters appearing in the video are having a conversation using only a voice, the user terminal may extract the original language information using only the audio file, and as another example, when the characters appearing in the video are having a conversation using only a sign language, the user terminal may extract the original language information using only the image file.

The user terminal may generate translation information using the original language information (720).

At this point, the user terminal may generate translation information by translating the original language information by itself, or may transmit the original language information to an external server that performs the translation service according to an embodiment, and receive and provide the translation information in order to prevent the computing overload, and there is no limitation in the implementation form.

In addition, the user terminal may enjoy contents with other users by mapping the original language information and the translation information to the video file and then sharing them with an external terminal through a communication network.

The user terminal may provide at least one among the original language information and the translation information together with the video, and there is no limitation in the providing method as described above. The user terminal according to an embodiment has an advantage of allowing a user to more easily enjoy video contents produced in languages of various countries, and allowing effective language education at the same time.

The configurations shown in the embodiments and drawings described in the specification are only preferred examples of the disclosed invention, and there may be various modified examples that may replace the embodiments and drawings of this specification at the time of filing of the present application.

In addition, the terms used in this specification are used to describe the embodiments, and are not intended to limit and/or restrict the disclosed invention. Singular expressions include plural expressions unless the context clearly dictates otherwise. In this specification, terms such as “comprises” or “have” are intended to specify presence of the features, numbers, steps, operations, components, parts, or combinations thereof described in this specification, and do not preclude the possibility of presence or addition of one or more other features, numbers, steps, operations, components, parts, or combinations thereof.

In addition, although the terms including ordinal numbers, such as “first”, “second”, and the like, used in this specification may be used to describe various components, the components are not limited by the terms, and the terms are used only for the purpose of distinguishing one component from other components. For example, a first component may be referred to as a second component without departing from the scope of the present invention, and similarly, a second component may also be referred to as a first component. The term “and/or” includes a combination of a plurality of related listed items or any one item of the plurality of related listed items.

In addition, the terms such as “˜ unit”, “˜ group”, “˜ block”, “˜ member”, “˜ module”, and the like used throughout this specification may mean a unit that processes at least one function or operation. For example, the terms may mean software or hardware such as FPGA or ASIC. However, “˜ unit”, “˜ group”, “˜ block”, “˜ member”, “˜ module”, and the like are not a meaning limited to software or hardware, and “˜ unit”, “˜ group”, “˜ block”, member“, module”, and the like may be configurations stored in an accessible storage medium and executed by one or more processors.

### DESCRIPTION OF SYMBOLS

100: User terminal
110: Input unit
120: Display

1. A user terminal comprising:
an extraction unit for extracting original language information for each character based on at least one among an image file and an audio file separately generated from a video file;
a translation unit for generating translation information obtained by translating the original language information according to a selected language; and
a control unit for providing at least one among the original language information and the translation information.

2. The terminal according to claim 1, wherein the original language information includes at least one among voice original language information and text original language information, and the translation information includes at least one among voice translation information and text translation information.

3. The terminal according to claim 1, wherein the extraction unit extracts voice original language information for each character by applying a frequency band analysis process to the audio file, and generates text original language information by applying a voice recognition process to the extracted voice original language information.

4. The terminal according to claim 1, wherein the extraction unit detects a sign language pattern by applying an image processing process to the image file, and generates text original language information based on the detected sign language pattern.

5. The terminal according to claim 1, wherein the extraction unit determines at least one among an age group and a gender of a character appearing in the audio file through a frequency band analysis process, maps character information set based on a determination result to the original language information, and stores the character information.

6. A control method of a user terminal, the method comprising the steps of:
extracting original language information for each character based on at least one among an image file and an audio file separately generated from a video file;
generating translation information obtained by translating the original language information according to a selected language; and
providing at least one among the original language information and the translation information.

7. The method according to claim 6, wherein the extracting step includes the steps of extracting the original language information for each character based on at least one among an image file and an audio file according to a communication means included in the video file.

8. The method according to claim 6, wherein the extracting step includes the steps of:
extracting voice original language information for each character by applying a frequency band analysis process to the audio file; and
generating text original language information by applying a voice recognition process to the extracted voice original language information.

9. The method according to claim 6, wherein the extracting step includes the step of detecting a sign language pattern by applying an image processing process to the image file, and generating text original language information based on the detected sign language pattern.

10. The method according to claim 6, wherein the extracting step includes the step of determining at least one among an age group and a gender of a character appearing in the audio file through a frequency band analysis process, mapping character information set based on a determination result to the original language information, and storing the character information.
